(19) United States
(12) Patent Application Publication
(10) Pub. No.: US 2009/0157803 A1
(43) Pub. Date: Jun. 18, 2009

(54) Method for capture, aggregation, storage, and transfer of internet content for time-shifted playback on a portable multimedia device

(75) Inventors: John Haggis, San Jose, CA (US); Francis Lau, Fremont, CA (US)

Correspondence Address: STAINBROOK & STAINBROOK, LLP, 412 AVIATION BOULEVARD, SUITE H, SANTA ROSA, CA, 95403, US

(73) Assignee: AERIELLE TECHNOLOGIES, INC., Mountain View, CA (US)

(21) Appl. No.: 12/282,025

(22) PCT Filed: Mar. 16, 2007
(86) PCT No.: PCT/US07/64247

§ 371 Date: Sep. 8, 2008

Related U.S. Application Data
(60) Provisional application No. 60/783,351, filed on Mar. 16, 2006.

(51) Int. Cl. G06F 15/16; G06F 17/30

(52) U.S. Cl. 709/203; 707/104.1; 707/E17.044

(57) ABSTRACT

A method for capture, aggregation, storage and transfer of Internet content for time-shifted playback on a portable multimedia device utilizing a content time-shifter system which is programmed and maintained via a web-based maintenance server, and schedules capture of content via on-line schedule listing and media listing services.

### BACKGROUND OF THE INVENTION

1. Technical Field

The present invention relates generally to a system and a method for capturing, recording, and playing back Internet content, and more particularly to a system and method for capturing, aggregating, storing, and transferring Internet content for time-shifted playback on a portable multimedia device.

2. Background Art

Cellular phones, Personal Digital Assistants (PDAs) and devices that play back compressed audio data, such as MP3 players and the APPLE® IPOD®, have grown increasingly more elaborate multimedia devices that can carry and “play” a variety of content formats: audio, video, still photos voice notes, text nots, schedules and more. All of the aforementioned devices have a wired or wireless method for electronically loading content, With the huge and expanding amount of content available on the internet, it is increasingly problematic for persons to locate content of interest. The content generally falls into two categories across all content formats: fixed and streaming content. [APPLE and IPOD are registered trademarks of Apple, Inc, Cupertino, Calif.]

Fixed content generally takes the form of a file in some form of electronic storage format. Once the location is determined, the file can be retrieved and transferred to a portable multimedia device. The main issue for the user is determining the name and location of the content of interest.

Another content category is streaming media. In contrast to fixed content, streaming media presents the challenge of file location, but also the challenge of scheduling, as streaming media changes content according to the time of day. The paradigm of streaming content is Internet radio, which has features characteristic of broadcast radio, but the transmission is over the worldwide network of interconnected computer networks that comprise the Internet. Internet radio content is ephemeral, as different content is disseminated at different times of the day, some never to be repeated. Because of this difference, streaming content cannot be accessed on-demand the way fixed content can be accessed.

Currently, thousands of traditional radio stations around the world simultaneously stream audio programming. Internet-based music services such as ITUNES® offer Internet based radio stations to users in nearly every genre imaginable. Pandora.com offers samples from the “Music Genome Project,” matching musical styles, lyrics and genre to user preferences, allowing the customer to store user created stations on the web site, all at no cost. [ITUNES is a registered trademark of Apple, Inc., Cupertino, Calif.]

In addition, XM and Sirius satellite radio systems stream online, as do countless other Internet-only stations. The vast amount of available programming generates conflicts, as users desire to listen to programs broadcast at inconvenient times or broadcast simultaneously on different stations.

In the television arena, several options are available for selective digital recording of television content. One option employs devices known as Digital Video Recorders (DVD). These systems provide the customer the ability to record television video content from cable or satellite television signals. Subscribers are provided with the ability to record live television signals for replay at a different time. This type of device, however, does not provide means to capture, record, and playback Internet content.

The method of the present invention is a content time-shifter system that addresses the needs for the discovery of interesting content, capturing streaming media according to time schedules, and automating these tasks with maximum convenience and ease.

Notable prior art references include U.S. Pat. No. 7,124,356, to Alsafadi, et al., which describes a method of operating a system including a digital network interconnected intelligent digital devices (IDDS) generating and receiving eXtensible Markup Language (XML) documents containing data and respective Document Type Definitions (DTDs) describing the data content. The method includes steps for transmitting a generated XML document from a first IDD to a second IDD, and, when the respective DTD for the generated XML document satisfies a predetermined criteria, operating on the data contained in the XML document at the second IDD. The second IDD maintains a list of trusted DTDs, and the predetermined criteria is equality between the name of the respective DTD and the name of a trusted DTD. Alternatively, the predetermined criteria is satisfied by inclusion of the name of a program residing on the second IDD in the respective DTD.

U.S. Pat. No. 7,065,778, to Lu, describes a method and system for providing media from remote locations that enables a user to utilize a personalized video recorder (PVR) to order and receive specific television shows unavailable from his or her television content provider. The PVR is coupled to the Internet such that it can receive an electronic programming guide (EPG) containing worldwide television programming from an EPG server computer. The PVR user utilizes the EPG to request delivery of a specific television show that is typically unavailable to him or her. Upon reception of the request, the EPG server computer locates via the Internet a PVR situated within a broadcast region of the requested television show. Next, the EPG server computer programs the PVR to record the requested television show when it is broadcast. Once the PVR records the television show, it is transmitted to the EPG server computer which transmits it to the requesting PVR.

U.S. Pat. No. 6,622,166, to Gile, et al., discloses an apparatus and method for allowing a user to acquire and record information from the Internet comprising a user interface that allows the user to identify at least one information service on the Internet that provides desired information and to select a desired completion time. A scheduler calculates a launch time to allow the desired information to be downloaded and recorded in its entirety before the desired completion time. A recording dispatcher begins downloading at the launch time the desired information from the information service. A recording device records the desired information to a recording medium.

Products currently on the market such as the SoundTrap streaming audio software or Internet Radio Recorder offer the recording of any digital audio being played on a computer, such as music or VOIP data. However, these products do not provide the ability to schedule recording sessions or capture fixed or streaming content, regardless of format.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein. Specifically, while the aforementioned art provide a means for physical recording and/or manipulation of video images or files, none address the scheduled capture of Internet content for later transfer to a multimedia device.

### DISCLOSURE OF INVENTION

The present invention is a method for capturing, aggregating, storing, and transferring Internet content for time-shifted playback on a portable multimedia device. The method utilizes a content time-shifter system which contains hardware and software. The content time-shifter system is programmed and maintained via a web-based maintenance server, and schedules the capture of content via on-line schedule listing and media listing services.

It is therefore an object of the present invention to locate content of interest for capture from the Internet.

It is another object of the present invention to locate streaming media and to schedule streaming media capture via an on-line searchable listing service that is publicly accessible from any Internet-accessible location at any time.

A further object or feature of the present invention is location and acquisition of fixed media via an on-line searchable listing service that is accessible from any location at any time.

Yet another object of the present invention to provide fixed media capture via a built-in aggregation (i.e. podcasts).

A still further object of the present invention to capture streaming media in a variety of formats.

Another object of the present invention to automatically update portable media devices.

Yet another object of the present invention to utilize an always on, low power appliance to manage the acquisition of Internet content.

A still further object of the present invention to enable remote maintenance of the content time-shifter system with options for archiving searches and results of the searches.

It is another, though not final, object of the present invention to allow integration of the content time-shifter system into broad featured appliances, such as clock radios, stereo receivers, digital video recorders, satellite radio receivers and portable multimedia device speaker systems.

Content time-shifter system functional components include:

Streaming Media Locating and Scheduling

Streaming media is located by an Internet accessible listing service which contains searchable listings of Internet radio and other streaming media services. The sources of these services are typically characterized by a number of features. The listing service has start and stop times associated with pre-designated programs, as well as the ability to set arbitrary start and stop times for recording a given source. In addition to searching and identifying the desired source, the listing service has the ability to record entries of the desired programs and recording sources and periods in general. These entries compose a schedule which is accessible by the content time-shifter system for making recordings at the scheduled times for alter transfer to a portable multimedia device.

Fixed Media Locating and Scheduling

Non-streaming media includes audio, video and other electronic content accessible on the Internet and usable by a portable multimedia device. The content time-shifter system can access this data in a variety of ways, depending on whether the content is static or periodically updated. When the content is static and the location is known, the Internet URL may be entered into a web page created for content time-shifter system control and maintenance. The content time-shifter system will then retrieve the actual content for later transfer to the portable multimedia device. Static content is also available from listing/licensing sources through a search using the web site of such a service. These selections are accessible by the content time-shifter system so that the content can be accessed and made available for later transfer to the portable multimedia device.

Fixed/Updating Media Location and Acquisition

When the fixed content is updated at some predetermined interval or time, such as a through a “podcast,” the Internet URL may be entered into a suitable location on the web page created for content time-shifter system control and maintenance. The content time-shifter system will retrieve this URL and act as an aggregation to retrieve new content at this URL source as it becomes available. In addition, a web-browser plug-in software program intercepts certain fixed and periodically-updated media types and sends the URL automatically to the content time-shifter via the server.

Streaming Media Capture

The content time-shifter system acquires the schedules for streaming media from a listing service and registers them in its internal scheduling system. At the scheduled time the content time-shifter system makes an Internet request for the stream and records it in a local file for later transfer to the portable multimedia device. If the format of the streamed media is incompatible with the portable multimedia device, the content time-shifter system performs the necessary conversion to a compatible format.

Appliance Form Factor

A key component of the content time-shifter system is that it utilizes an appliance that has a minimum of local features. This appliance utilizes very little power compared to a personal computer, thus encouraging the user to leave it in an “ON” state at all times. Continuous and uninterrupted (“always on”) operation allows maximum flexibility for recording scheduled content. All of the key features are accessed through a web site which is accessible from anywhere in the world that has Internet access, so that the appliance itself requires no interaction, except for the convenience of docking the user's portable multimedia device.

Automatic Update of Multimedia Devices

By placement of the multimedia device into a docking cradle, the content time-shifter system recognizes and updates (synchronizes) the device automatically. The content time-shifter system can also be networked or encapsulated into a router appliance for remote update of the portable multimedia device. This requires that a software driver run on the appliance, and it must be able to contact the content time-shifter system externally through the Internet. User-controlled manual-updating is also available as a setting.

Remote Maintenance

Maintenance of the content time-shifter system includes deleting and changing the attributes of content files which are temporarily stored. Additionally, global settings on the content time-shifter system may be changed. Maintenance is accomplished through a web-based graphical user interface (GUI). A maintenance server displays the current state of the content time-shifter system and the all of the content files contained therein. The content time shifter contacts the maintenance server at regular intervals to receive the commands to perform the maintenance functions. This “polling” function works behind fire-walls and proxies.

Integration into Other Appliances

The content time-shifter system comprises a set of software functions portable to a variety of platforms. This enables it to be incorporated into a variety of appliances or to function as a standalone box. Clock radios, Internet radios, personal video recorders, digital video recorders, stereo component receivers, tuners and even kitchen automation may include and integrate this capability.

There has thus been broadly outlined the more important features of the invention in order that the detailed description that follows may be better understood, and in order that the present contribution to the art may be better appreciated. Additional objects, advantages and novel features of the invention will be set forth in part in the description as follows, and in part will become apparent to those skilled in the art upon examination of the following. Furthermore, such objects, advantages and features may be learned by practice of the invention, or may be realized and attained by means of the instrumentalities and combinations particularly pointed out in the appended claims.

Still other objects and advantages of the present invention will become readily apparent to those skilled in this art from the following detailed description, which shows and describes only the preferred embodiments of the invention, simply by way of illustration of the best mode now contemplated of carrying out the invention. As will be realized, the invention is capable of modification in various obvious respects without departing from the invention. Accordingly, the drawings and description of the preferred embodiment are to be regarded as illustrative in nature, and not as restrictive.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a block diagram of the method for capture, aggregation, storage and transfer of Internet content for time-shifted playback on a portable multimedia device; and

FIG. 2 is a block diagram of another embodiment of the method for capture, aggregation, storage and transfer of Internet content for time-shifted playback on a portable multimedia device.

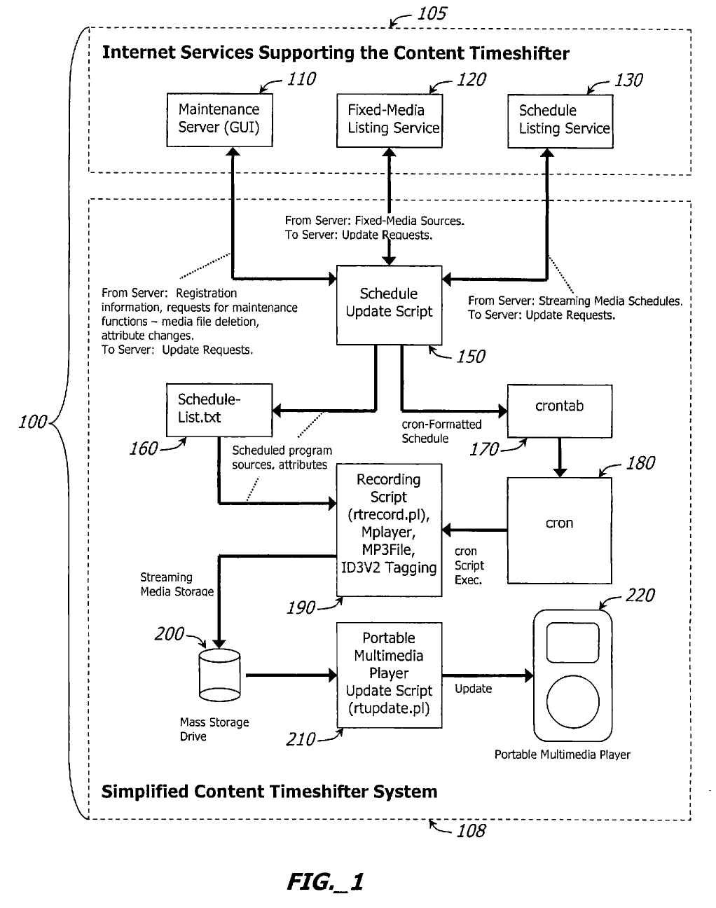

### DRAWING REFERENCE NUMERALS—FIG. 1

100 method for capture, aggregation, storage and transfer of Internet content for time-shifted playback on a portable multimedia device

105 Internet services

108 content time-shifter system

110 maintenance server

120 fixed media listing service

130 schedule listing service

150 update script

160 schedule list file

170 scheduled event table (confab)

180 scheduling software task (croon)

190 recording script

200 mass storage device or drive

210 update script

220 portable multimedia device

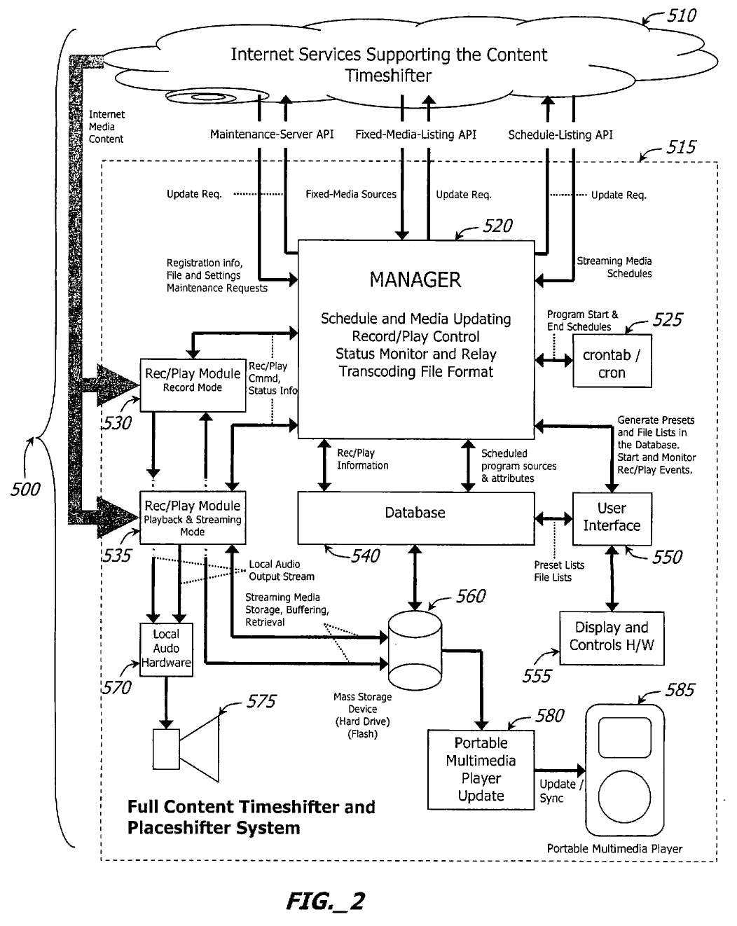

### DRAWING REFERENCE NUMERALS—FIG. 2

500 advanced method for capture, aggregation, storage and transfer of Internet content for time-shifted playback on a portable multimedia device

510 Internet services

515 content time-shifter system

520 manager of scheduling, recording, and playback tasks

525 scheduled event table (confab) and scheduling task (croon)

530 record/play software module with streaming, ring-buffering, and file management

535 record/play software module with streaming, ring-buffering, and file management

540 database service

550 user interface software module

555 user interface hardware - display, buttons, knobs

560 mass storage device or drive

570 audio output hardware

575 local speaker

580 update software module

585 portable multimedia device

### BEST MODE FOR CARRYING OUT THE INVENTION

Referring first to FIG. 1, there is illustrated therein a first preferred embodiment of the inventive system and method for capture, aggregation, storage and transfer of Internet content for time-shifted playback on a portable multimedia device, generally denominated 100 herein. This embodiment may be implemented in a number of forms.

The inventive system and method utilizes Internet services 105 and a content time-shifter system 108 to accomplish recording of fixed and streaming Internet content. A maintenance server 110 provides the graphical user interface to the user for registration, configuration and maintenance functions. The maintenance server 110 also receives HTML requests from an update script 150 and responds to the user's commands to carry out such maintenance functions as deleting files or changing attributes.

A catalog of free or licensed fixed media files stored on electronic media is acquired by the update script 150 from a web-based fixed media listing service 120, along with streaming media such as Internet radio or video, through a web-based schedule listing service 130. The update script 150 is a process that runs at regular intervals, routinely polling the listing services for changes in registration, configuration, content sources and content scheduling through the use of a web server content retrieval program, such as the open source utility “wget,” to make the HTML requests and receive replies. The update script 150 creates and maintains user accounts in response to the maintenance server 110. The update script 150 also queues fixed source media items for downloads in response to fixed media listing service 120 reports, and parses schedule information from the schedule listing service 130.

With the foregoing information, two outputs are created: a schedule list file 160, which contains all of the details of the sources and attributes of the content to be recorded, and a task table (crontab) 170 schedule to invoke a recording script 190. A software utility command 180 such as the Linux utility “cron” reads schedule files and executes specified commands at a given time.

The recording script 190 is a process run by the software utility command 180, such as cron, at the time of each recording of content which looks up recording sources in the schedule list file 160 and starts streaming recording via the open source Mplayer Linux utility. The recording script 190 also monitors scheduled end times for recording schedules and terminates recording in response to the schedule.

File format conversions are carried out by the recording script 190 based on the preferred format of the target multimedia player. Text and graphical information related to the recorded content is added to the file through the use of an ID3 tag. This information becomes available to the user upon playing the recorded content on a multimedia device, such as an IPOD® or MP3 player. Recorded content files are then transferred to a mass storage device 200, such as a compact flash card or a hard disk drive. An update script 210 monitors a cable or cradle device for insertion of a multimedia device 220. The update script 210 identifies the player, correlates it to a particular user and uploads any new content files which are allocated to that player. Uploading is accomplished through of the open source “gnupod” script utilities.

Referring next to FIG. 2, there is illustrated a second, alternative, preferred embodiment for the system and method for capturing, aggregating, storing, and transferring Internet content for time-shifted playback on a portable multimedia device. This alternative embodiment is generally denominated 500 herein.

In this second preferred embodiment, the implementation takes advantage of a sophisticated database and superior software organization to enhance the performance, scalability, and management of the media.

The inventive system and method utilizes Internet services 510 and a content time-shifter system 515 to accomplish recording of fixed and streaming Internet content. The Internet services 510 provide registration, configuration, maintenance, catalogs, lists, items, and schedules, as described in the first preferred embodiment.

The manager module 520 gets updates from the Internet services 510 and stores all the information on mass storage 560 through the database engine 540. This information includes registration information, catalogs, schedules, file lists, file attributes, settings, URLs, and so forth.

The manager 520 converts the schedule into a format suitable for storage in the crontab 525 for processing on scheduled events by cron 525. At the appointed scheduled times, cron 525 initiates an exchange with the manager 520 to start or stop a recording or other scheduled event.

The user interface 550 retrieves file lists and streaming sources from the database 540 and displays them on the appliance, with interactive access by the user via the controls 555 to play or record the listed items. The user interface sends these commands to the manager 520 to invoke record/play modules 530, 535 to carry out the requests. The manager 520 also sends status information to the user interface 550 so that it can track operational states such as recording or playing in progress, and dynamic progress in a given recording or playback.

The record/play modules 530, 535 include multiple processes run by the manager 520 at the time of each scheduled recording or user-interface-invoked asynchronous command for recording or playing some content.

From a recording schedule (via cron 525) or a user-invoked recording via the user interface 550, the manager 520 starts a new instance of the record/play module 530 to carry out the recording. The manager 520 receives a database reference for the recording source, and looks up the actual information in the database 540. The record/play module 530 handles the source intelligently whether it by a streaming URL, a fixed file URL, a podcast, a local file on the mass storage, or whatever other format the system handles. It starts streaming or copying the information from the source, through a ring buffer, to a local file. It uses the ring buffer in the case that it gets a play command from the manager 520 to start playing the stream in progress. In this case, it sends a copy of the stream to the local audio hardware 570 to play out the local speaker 575. A user fast-forward or rewind command from the user interface 555, 550 through the manager 520 causes it to shift its audio-output pointer along the ring buffer to accommodate the request. In the case of a scheduled or user-invoked recording, cron 525 sends a request at the appropriate ending time to the manager 520 which terminates the record/play module 530.

From a user-invoked selection to play a local file or live stream, the user interface 550, 555 sends a command to the manager 520, which starts a new instance of the record/play module 535 in playback mode. In a manner similar to record mode, the record/play module 535 opens the source and passes the information through its ring buffer to the local audio hardware 570 for playback on the local speaker 575. It uses the ring buffer as previously described to support fast-forward and rewind within a live stream.

When necessary, file format conversions are carried out at the termination of recording by the manager 520 based on the preferred format of the target multimedia player. Text and graphical information related to the recorded content is added to the file's entry in the database 540 and to the file on the mass storage device 560 through the use of an ID3 tag. This information becomes available to the user upon playing the recorded content on a multimedia device 585 such as an IPOD® or MP3 player.

An update module 580 monitors a cable or cradle device for insertion of a multimedia device 585. The update module 580 identifies the player, correlates it to a particular user, and uploads any new content files allocated to that player.

Having fully described the best mode of practicing the present invention, many other equivalents and alternative embodiments will be apparent to those skilled in the art. These and other equivalents and alternatives are intended to be included within the scope of the claims to the present invention.

What is claimed as invention is:

1. A method for capturing, aggregating, storing, and transferring Internet content for time-shifted playback on a multimedia device, said method comprising the steps of:
connecting to a web-based maintenance server for registration information, configuration, update requests, attribute changes, maintenance functions and responses to user requests;
acquiring content schedules and content sources for streaming media from a web-based schedule listing service;
acquiring the location of fixed media from a web-based fixed media listing service;
utilizing an update script to poll said web-based maintenance server, web-based schedule listing service and web-based fixed media listing service for changes in said registration information, said configuration, said location of fixed media, said content sources and said content schedules;
indexing said content schedules, content sources for streaming media and said location of fixed media for content recording;
creating a schedule list file which contains a list of all said content schedules and said location of fixed media from;
formatting said content schedules into a task table and to invoke a recording script; utilizing a software utility command to check said task table;
utilizing said recording script process to combine said schedule list and said task table;
recording said Internet content according to said schedule list;
creating a recorded file;
storing said recorded file on a mass storage device, and;
transferring said recorded file to said multimedia device through the use of an update script.

2. The method as recited in claim 1, wherein said task table is a crontab scheduling table.

3. The method as recited in claim 1, wherein said software utility command is a Linux CRON scheduling utility.

4. The method as recited in claim 1 wherein said recording of said Internet content is performed by an open source Mplayer Linux utility.

5. The method as recited in claim 1, wherein said recorded file is converted to a format compatible with said portable multimedia player.

6. A system for capturing, aggregating, storing, and transferring Internet content for time-shifted playback on a target portable multimedia device, said system comprising:
Internet services; and
a content time-shifter system.

7. The system of claim 6, wherein said content time-shifter system includes a catalog of free and/or licensed fixed media digital files stored on electronic media, and said Internet services includes a maintenance server for providing a graphical user interface to a user for use in registering, configuring, and maintaining functions, and a fixed-media listing service for acquiring fixed media files and streaming media.

8. The system of claim 6, wherein said fixed media listing service acquires streaming media using a web-based schedule listing service.

9. The system of claim 6, wherein said fixed media listing service acquires fixed media files with an update script.

10. The system of claim 9, wherein said update script includes polling means for polling said fixed media listing services for changes in registration, configuration, content sources and content scheduling through the use of a web server content retrieval utility

11. The system of claim 10, wherein said web server content retrieval utility is wget.

12. The system of claim 10, wherein said update script includes account maintenance means to create and maintain user accounts in response to said maintenance server.

13. The system of claim 10, wherein said update script further includes queueing means to queue fixed source media items for downloads in response to reports from said fixed media listing service, and schedule parsing means for parsing schedule information from said schedule listing service.

14. The system of claim 6, wherein said content time-shifter system includes:
a schedule list file containing details of the sources and attributes of the Internet content to be recorded;
a software utility command, which includes a recording script, said software utility command for reading schedule files and executing specified commands at a given time, including running said recording script;
a task table schedule for invoking said recording script; and
file transfer means for transferring recorded Internet content files to a mass storage device.

15. The system of claim 14, wherein said software utility command runs said recording script at the time of each recording of Internet content and includes both look up means for looking up recording sources in said schedule list file, and streaming content recording means for starting streaming content recording.

16. The system of claim 15, wherein said streaming content recording means is the Mplayer Linux utility.

17. The system of claim 14, wherein said recording script is cron.

18. The system of claim 14, wherein said software utility command is the Linux utility cron.

19. The system of claim 14, wherein said task table schedule is crontab.

20. The system of claim 14, wherein said recording script also includes monitoring means for monitoring scheduled end times for recording schedules and terminates recording in response to the recording schedules.

21. The system of claim 20, wherein said recording script further includes file format conversion means for performing file format conversions based on the preferred format of the target multimedia player.

22. The system of claim 20, further including an ID3 tag for adding text and graphical information related to the recorded content is added to said schedule list file, wherein the text and graphical information is available to the user upon playing the recorded Internet content on a target multimedia device.

23. The system of claim 6, further including an update script for recognizing the connection of a multimedia device, and wherein said update script identifies the player, correlates it to a particular user, and uploads any new Internet content files allocated to that player.

24. The system of claim 6, further including upload means.

25. The system of claim 24, wherein said uploading means is the gnupod script utility.

26. The system of claim 6, wherein said Internet services includes a maintenance server for providing a graphical user interface to a user for use in registering, configuring, and maintaining functions, and a fixed-media listing service for acquiring fixed media files and streaming media, and wherein said content time-shifter system includes:
a database of free and/or licensed fixed media digital files stored on electronic media;
a manager module having update means for obtaining updates from said Internet services, storage means for storing said updates on mass storage through a database engine, conversion means for converting a schedule into a format suitable for storage in a crontab for processing on scheduled events by cron, whereby at scheduled times cron initiates an exchange with said manager module to start or stop a recording or other scheduled event; and
a user interface for retrieving and displaying file lists and streaming sources from said database, and having user control means such that the user can control the playing or recordation of listed items.

27. The system of claim 26, wherein said user interface send user commands to said manager module to invoke record/play modules to carry out the user requests.

28. The system of claim 27, wherein said manager module includes means to send status information to said user interface for tracking operational states such as recording or playing in progress, and dynamic progress in a given recording or playback.

29. The system of claim 27, wherein said record/play modules include multiple processes run by said manager module at the time of each scheduled recording or user-interface-invoked asynchronous command for recording or playing some content.

30. The system of claim 26, wherein said recording script further includes file format conversion means for performing file format conversions based on the preferred format of the target multimedia player.

31. The system of claim 26, further including an ID3 tag for adding text and graphical information related to the recorded content is added to said schedule list file, wherein the text and graphical information is available to the user upon playing the recorded Internet content on a target multimedia device.

32. The system of claim 26, further including an update script for recognizing the connection of a multimedia device, and wherein said update script identifies the player, correlates it to a particular user, and uploads any new Internet content files allocated to that player.

33. The system of claim 26, further including upload means.

34. The system of claim 34, wherein said uploading means is the gnupod script utility.
